(19) United States
(12) Patent Application Publication
(10) Pub. No.: US 2017/0361473 A1
(43) Pub. Date: Dec. 21, 2017

(54) SERRATED KNIFE

(71) Applicant: SPORT MANUFACTURING GROUP INC., Forest Hills, NY (US)

(72) Inventor: Anton Tkachenko, St. Petersburg (RU)

(21) Appl. No.: 15/185,217

(22) Filed: Jun. 17, 2016

(51) Int. Cl. B26B 1/02

(52) U.S. Cl. CPC B26B 1/02

(57) ABSTRACT

A knife having a blade and a handle. The blade includes at least one cutting edge, a tip and a base. The handle includes a connection mechanism connecting the base of the blade to the handle. The cutting edge of the blade includes a plurality of serrated groups, each serrated group having at least a first arched recess with a first dimension, a second arched recess with a second dimension, and a third arched recess with a third dimension. The second dimension is at least 30% greater than the first dimension, and the third dimension is at least 30% greater than the second dimension. The arched recesses of each serrated group are arranged in ascending order in a direction from the tip of the blade to the handle. Multiple serrated teeth are formed between adjacent arched recesses.

### FIELD OF THE INVENTION

The presently disclosed principles and inventions are related to serrated folding knives.

### BACKGROUND OF THE INVENTION

Knives with serrated cutting edges are old and well-known in the prior art. The serrated blades are conventionally used in household tools, such as table knives and meat cutting knives and in a wide variety of saw blades.

However, other than in saw blades, serrated cutting devices have not proved particularly useful in hand cutting of ropes or other fibrous materials. Most often, the cutting edge of the blade includes a plurality of sharp teeth formed along the edge, all of them being of the same size. Such blades are particularly ineffective when a user needs to cut through a thick rope.

### SUMMARY OF THE INVENTION

In one general aspect, the invention provides a knife having a blade and a handle. The blade includes at least one cutting edge, a tip and a base. The handle includes a connection mechanism connecting the base of the blade to the handle. The cutting edge of the blade includes a plurality of serrated groups, each serrated group having at least a first arched recess with a first dimension, a second arched recess with a second dimension, and a third arched recess with a third dimension. The second dimension is at least 30% greater than the first dimension, and the third dimension is at least 30% greater than the second dimension. The arched recesses of each serrated group are arranged in ascending order in a direction from the tip of the blade to the handle. Multiple serrated teeth are formed between adjacent arched recesses.

In one specific aspect, the serrated teeth are sharpened on one side of the blade only.

In another specific aspect, the serrated teeth are sharpened on both sides of the blade.

In another specific aspect, the knife is a folding knife, and the connection mechanism is a pivot mechanism rotatably connecting the base of the blade to the handle.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF DRAWINGS

The invention is illustrated in the figures of the accompanying drawings which are meant to be exemplary and not limiting, in which like references are intended to refer to like or corresponding parts, and in which:

FIG. 1 is a side view of the folding knife in its open position with the serrated blade in accordance with the preferred embodiment of the invention;

FIG. 2 is a side view of the serrated knife blade;

FIG. 3 is an enlarged partial view of the serrated portion of the knife blade; and

FIG. 4 is a schematic illustration of the cutting process using the serrated knife blade.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

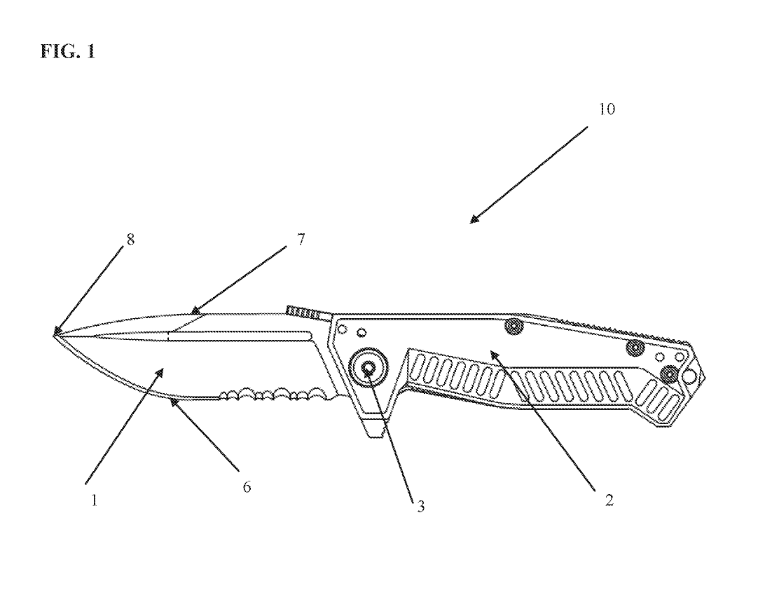

Referring now to the drawings, in which like numerals represent the same or similar elements, and, initially, to FIGS. 1-3, there is shown a folding serrated knife 10, constructed in accordance with one preferred embodiment. Knife 10 preferably includes a handle portion 2 and a knife blade 1. The knife blade 1 is pivotally connected to the handle portion 2 by a pivot mechanism 3 so as to allow the blade to rotate between a closed, or folded, position (not shown) and an open position (shown in FIG. 1). In the preferred embodiment, the pivot mechanism 3 includes a pivot pin and a pivot screw. However, any other known rotary engagement between the blade and the handle portion can be utilized. Although the knife 10 is shown as a folding knife with one cutting edge, it should he understood by a person skilled in the art that the principles of the invention can be applied to any non-folding knife with any number of sharpened edges.

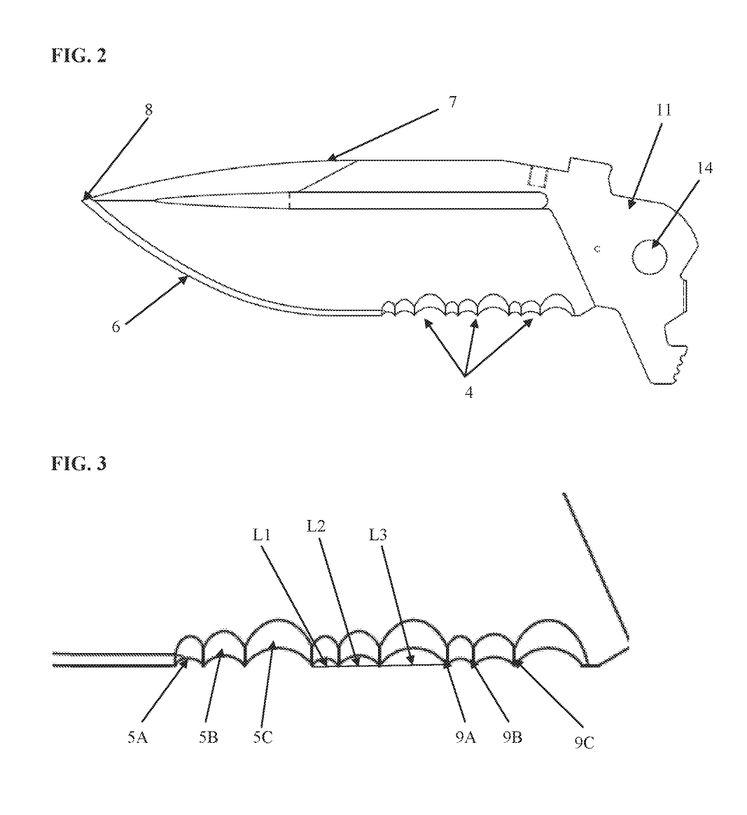

As more particularly shown in FIG. 2, blade 1 has a sharpened cutting edge 6, a tip 8 and a non-sharpened non-cutting edge (or “butt” of the blade) 7. The cutting and non-cutting edges are located opposite each other. The blade also includes a base portion 11 with an aperture 14 through which the pivot pin of the pivot mechanism 3 extends to rotatably connect the blade to the handle portion.

In the illustrated embodiment, as more particularly shown in FIG. 3, the cutting edge of the blade includes several groups 4 of arched recesses 5A-5C thus forming multiple cutting teeth 9A-9C in each group 4. The teeth are sharpened on one or both sides of the blade relative to the blade's plane of symmetry. As shown in FIG. 3, each arched recess 5A-5C of each group 4, has a different dimension (i.e. the diameter) L. In the preferred embodiment dimensions L of the adjacent recesses of one group 4 differ by more than 30% from each other, and are arranged in ascending order in the direction from the tip 8 of the blade to its base/handle. In other words, in each group 4, dimension L3 of the arched recess 5C is more than 30% greater than the dimension L2 of the arched recess 5B, which is, in turn, more than 30% greater than the dimension L1 of the arched recess 5A. Although, the dimension L is shown as a diameter of each arched recess, it should be understood by a person skilled in the art, that dimension L can also refer to the depth of each arched recess, and that depths of the adjacent arched recesses in one group differ correspondingly.

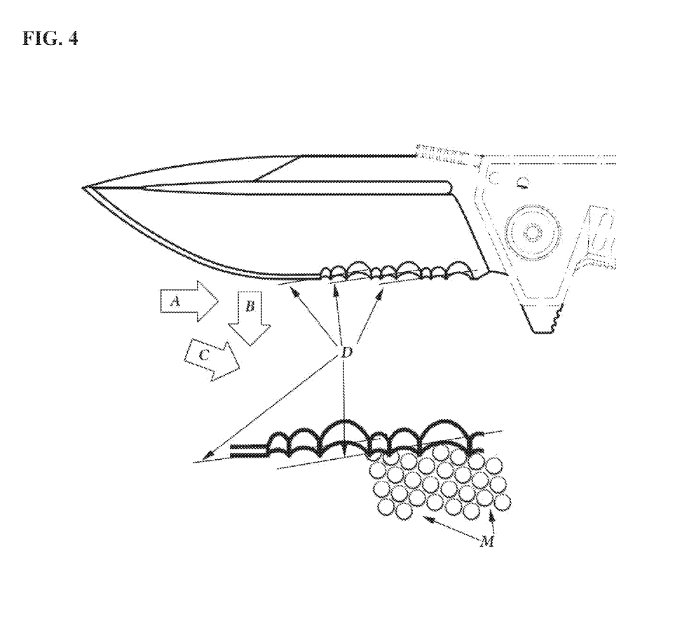

The process of cutting a material using the serrated blade of the present invention is illustrated in FIG. 4. Arrow “A” indicates the direction of blade movement during cutting of the material with the serrated side of the blade. Arrow “B” indicates the direction of the blade pressure on the material being cut produced as a result of the knife user's effort. Arrow “C” indicates the sum of the pressures exerted during cutting. Letter “D” denotes lines passing through the vertices of the curvature of the arched recesses 5A-5C in each group 4. As shown in FIG. 4, because the dimensions of the recesses increase by more than 30%, line “D” is significantly inclined with respect to the direction “A”. Letter “M” denotes the material conventionally depicted as circles of fibrous material (front section). Because lines “D” are inclined at an angle to the direction of blade movement during cutting, each group 4 better grips the material being cut. Thus, when cutting the fibrous material “M” and when the serrated portion of the blade moves through the incision, each group 4 captures the fibers not only due to the concave shape of the contour of each of the arched recess, but also because the series arrangement of the recesses in each of the groups is inclined to the handle of the blade. A better grip on the material contributes to more efficient slicing.

The figures in this disclosure are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above described exemplary embodiments, but should be defined only in accordance with the following claims and their equivalents.

What is claimed is:

1. A knife comprising:
a blade having at least one cutting edge, a tip and a base; and
a handle having a connection mechanism connecting the base of the blade to the handle;
wherein the cutting edge of the blade includes a plurality of serrated groups, each serrated group having at least a first arched recess with a first dimension, a second arched recess with a second dimension, and a third arched recess with a third dimension, wherein said second dimension is at least 30% greater than said first dimension, wherein said third dimension is at least 30% greater than said second dimension, wherein said arched recesses of each serrated group are arranged in ascending order in a direction from the tip of the blade to the handle, and wherein serrated teeth are formed between adjacent arched recesses.

2. The knife according to claim 1, wherein said serrated teeth are sharpened on one side of the blade

3. The knife according to claim 1, wherein said serrated teeth are sharpened on both sides of the blade.

4. The knife according to claim 1, wherein said knife is a folding knife and wherein said connection mechanism is a pivot mechanism rotatably connecting the base of the blade to the handle.
